(19) United States
(12) Patent Application Publication
(10) Pub. No.: US 2022/0315327 A1
(43) Pub. Date: Oct. 6, 2022

(54) Automatic Gravity Enforced Looking Device for a Wheeled Trash Container with Hinged Lid

(71) Applicants: ROBERT C. MUIS, Paulden, AZ (US); SUSANNE MUIS, Paulden, AZ (US)

(72) Inventors: ROBERT C. MUIS, Paulden, AZ (US); SUSANNE MUIS, Paulden, AZ (US)

(21) Appl. No.: 17/300,153

(22) Filed: Apr. 1, 2021

(51) Int. Cl. B65F 1/16; B65F 1/14; B65F 1/02

(52) U.S. Cl. CPC B65F 1/1615; B65F 1/1646; B65F 1/1473; B65F 1/02

(57) ABSTRACT

The present disclosure relates to an automatic gravity inforced lid locking device offered for purchase to the general public, self-appliable and removable by hook and strap to the outer surface of a residential plastic wheeled trash container instantanously. Certain unauthorized measures to attach many other types of gravity inforced mechanisms onto commerical owned disposal service containers have proven unfavorable due to the damage on the receptacles when drilled with holes to affix the devices. This can be a costly mistake to the customer indicated by a higher charge on their bill due to alterations of private property. Whereas, the present disclosure is a low profile locking mechanism and is automated public utility company friendly. Other specific examples of locking mechanisms (unless privately owned) for trash containers, do not attempt, at the very least, to address the complicated technique for mounting these devices or the numerical value to the utility waste service company on the destructive result to the rented receptacles. Rather, the present disclosure relates to further improve the means of locking a wheeled trash container lid, wherein the device keeps the lid of said trash container locked by gently holding it firmly closed until either a user manually releases a counterweight that unlockes the mechanism or is unlocked from a locked position as the standing upright container is tilted forward and empied by a curbside commerical disposal truck. Therefore, the spirit of the self-appliable and removable means of the present disclosure verses the alternative descision of other devices to modify waste receptacles by drilling holes into them for attachable means, defines a less destructive solution.

### FIELD OF THE INVENTION

The present invention relates to a self-appliable and removable lid lock for a conventional residential wheeled trash container. More particularly, the present invention relates to an automatic gravity inforced device to impove the means of locking and unlocking the hinged lid of a wheeled trash container. An advantage of the present disclosure of the self-appliable and removable lock and unlock device is not only that it can be purchased by the general public and be self attached effortlessly to a wheeled trash container, but can help avoid damage to a commercially owned receptacle due to complicated techniques other types of gravity inforced mechanisms require to drill holes in the plastic for mounting. A user can manually unlock the present invention by pulling an arm with a counterweight outwardly therefrom the device when attached to said trash container to disengage the mechanism and/or as the device is attached to said trash container standing in an upright position, is able to release the hinged lid from a locked position using the force of gravity as it tilts forward to be emptied by a waste service collection truck.

### BACKGROUND OF THE INVENTION

As is known, conventional residential wheeled trash containers typically are invaded by scores of unwanted pests which selectively rummage through household bags of refuse at will because of insufficiient measures to keep the hinged lids closed, and with regard to the forgoing, giving free access also to unauthorized individuals to fill them at the costly expense to the customer. As another comparison, it is common for a customer to roll a wheeled trash container for placement in front of their residence for collection only to be struck by the hinged lid when strong winds throw it back suddenly without warning. This may be dangerous and cause injury, depending on the circumstance to the user. Most automated public utility garbage truck companies usually do not provide a means to their customers of locking the smaller wheeled trash containers for obvious reasons due to the finanical impact to supply every customer and the time involved for the drivers to manually reset each pickup if certain mechanisms used are not depenable to work properly on collection day.

### SUMMARY

The object of the present invention is to further impove the means of locking and unlocking the hinged lid of a wheeled trash container, of the type comprising a fastenable housing structure on said container with strap, hooks and two rigid pivoting arms connected by a link plate; one horizonal and the other vertical. When said device has been properly hung on the outside edge of said container and the hinged lid closed, the upper horizonal pivoting arm holds the lid down in a locked position. As the receptacle is tilted forward, lifted and turned upside down for dumping this reaction triggers the lower vertical arm with a counterweight to swing away from the housing structure releasing the upper horizonal pivoting arm to move away from the lid and give clearence for dumping.

An illustrative embodiment of the wheeled trash container for the means of locking and unlocking the hinged lid using the force of gravity with the desire to prevent unauthorized access when the trash container is on the ground in an upright position without interference during the dumping process, discloses a device comprising a housing structure that directly engages the upper rim of a trash container below its hinged lid, by an upper arm whose purpose is to rest on top of the receptacle lid when in a closed position, for a locking means to prevent the lid from opening; and a lower arm with a counterweight both spaced-apart, each with a single affixed pivot point connected respectively by a movable link plate that directly serves as a locking or unlocking means when the container hinged lid is open or closed. In addition, when the trash container is in an upright position and waiting to be emptied, the key unlocking means of the device happens when the lower pivoting arm that rests in a vertical position against the receptacle pushes the link plate therefrom the trash container while it is tilted forward using the force exerted by gravity to raise the horizonal position of the upper arm to a vertical one above the receptacle. Furthermore, both pivoting arms comprise two stop tabs that have the added advantage of reducing movement when device is geometrical ingaged.

In further embodiment, the disclosure describes a pair of hooks on the housing structure that can attach the device to a trash container by fastening it under the hinged lid onto the edge of the outside wall. As a variant, said device may include an abutment acting as a retaining wall to resist lateral movement as well as a means capable of both keeping the mechanism in a upright position or keeping adequate distance therefrom while in direct contact with the container body. Thus, according to the invention, when it is hooked on the lip edge and tightly mounted with particular ease by a strap to the trash container's front lower handle, it can readily be installed on any existing container. When the trash container is tilted to a 90 degree angle for dumping, the first arm with the counter-weight pivots outward by gravity pushing against the link and forcing the second arm from a locked position to an unlocked position giving clearence to the trash container's hinged lid for waste collection. When this object is accomplished because the trash container has been emptied and placed back on the ground after dumping, and the hinged lid is closed, the device returns to facilitate a locked position.

With regard to the foregoing, one embodiment of the disclosure provides a inexpensive locking mechanism for the general public to purchase and use without permanent alteration or damage to a privately owned commerical disposal service's property.

In a further embodiment, the disclosure describes a simple operation of a gravity operated device for locking a hinged lid to a trash container.

An advantage of the present disclosure may be that the locking device is able to automatically unlock during the process of dumping to eliminate any need for a user to manually unlock and lock during waste collection.

Additional objects and advantages of the disclosed device will be set forth in part in the description which follows, and/or can be learned by practice of the disclosed embodiments. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

### DESCRIPTION OF THE RELATED ART

The related art of interests describes various devices for locking the hinged lids of residental trash containers that are permanently attached, intended to be unlocked when emptied by tilting into a waste collection service truck and then returned to a locked, upright position, although none discloses the present invention. There is a need for a dependable gravity inforced locking/unlocking device which permits instantaneous attachment for use to most conventional wheeled trash containers.

The related art will be discussed in order of perceived relevance to the present invention. These patents neither suggest nor do they teach the advantage of a hook and strap-on, lock and unlock mechanism offered for purchase to the general public to further improve an easily attachable and detachable means without damage to a waste receptacle by other examples shown.

As is known, automated public utility garbage truck companies do not supply a means of a lid lock device to the general public to solve the problem for unauthorized parties to gain access to the smaller waste collection containers waiting to be emptied. Conventional means to typically keep a smaller wheeled trash container hinged lid closed is frustrating for the general public at times and occanionally correct the problem by drilling holes into the plastic container body to attach a make-shift contrivance to hold the lid shut.

Moreover, many locking devices for locking the lids of trash containers have been proposed to solve these problems set forth in the specifications of claims herein, however, most locking devices affixed to the container rentals for public useage are applied by means of drilling holes into plastic receptacles solely for the purpose of attachment and are gravely unexceptable as indicated by the garbage truck companies due to unnecessary damage to their property. It should be noted, that a monotary value could be placed on the customer serving an excellent reason to deviate from this standard. It will be understood that an attempt to render a broader scope of a more practical application has been considered in the present invention as it is directly attached by means of hook and strap capability. In basic concept, the related art of interest, intended for ownership specifications to the public, can manually attach quickly without damage or prolonged wear and tear to the receptacle, perform its primary function and not interfere with the waste collection operation process.

Many locking devices for wheeled trash containers range in numbers to solve the problem of entry. For example, French Patent No. 2,721,912 to the assignee describes a locking device comprising a pivoting part pivotably mounted on a large, rectangular container referred to as “dumpster” body inside a protective casing. When said dumpster is upright, this pivoting part assumes a locked position in which it keeps the lid in a closed position. When the container is tilted for emptying, the pivoting part, by force of gravity, moves from its locked position to an unlocked position. Due to a dumpster's typically bulky size, the mechanism is generally directed to company owned containers that can be attached permanently.

The dumpster shown in U.S. Pat. No. 5,149,153 shows a huge container with hinged lids that solved the unauthorized use problem, by again, permanently attaching a self-disengaging lock between the hinged lid and the body of the dumpster, though, a key is required to release a latch. However, when locked, the latch is automatically released as the dumpster is tilted forward.

Although the smaller, residential trash containers have less problems with unauthorized entry which makes the problem seem unwarranted, smaller trash containers are prone to opening in high winds and animals have easier access. Refer to U.S. Pat. No. 5,738,395 that discloses a self-releasing latch arrangement applied to a coventional trash container having a hinged lid and being liftable and dumpable by the usual garbage truck. The latch arrangement comprises one or more keeper members, and once again, is permanently attached to the container outwardly thereof and overhanging thereform manually swinging the weight away from the keeper thereby emptying the container.

For more examples of prior art of locking devices for the hinged lid of a conventional trash container, especially gravity inforced mechanism attachments include U.S. Pat. No. 5,772,264, that discloses a gravity operated latch hook built in such a way as to incorporate a counterweight design by means of a hinge-plate and pin assembly, permitting the lid to open disengaging a striker when the container is set upright. Once again, the example of prior art is attached to the underside of the container's lid that requirers machine drilled holes into the receptacle with nut and bolt assembly.

U.S. Pat. No. 5,224,744 discloses a locking piece mounted to pivot between a position assuring the locking and unlocking position releasing the cover. The operating member is a movable weight mounted for guided sliding movement arranged so that a translatory movement in one direction of the operating member produces a rotation of the locking piece in the unlocking direction. Consequently, the device again is fabricated onto the receptacle.

While the embodiments of U.S. Pat. No. 5,772,061, claim a catch that includes a sliding/rolling locking member which is also the gravity element as indicated, the method of attachment connectable to the container requires complete assembly.

The disadvantages of the prior art designs disclosed in the patents listed herein are not only the difficulties of the lack thereof to the general public to attach such assembilies onto a commerically owned small residential trash containers quickly within seconds without the need of using any tools to drill holes for nuts and bolts or cutting edge welded applications, even though these devices fit most models of small wheeled trash containers with hinged lids on the market today, nor even though they may require some expertise for complexity and adjustment to assemble them when applied, but It must be understood that while the preferred methods seen possible, the most important factor to the equation is that if trash containers are not privately owned permission to do so must be granted by the commerical disposal service company.

However, none provide a hook and strap capability to facilitate a user to manually apply said device sufficiently and instantanously to a receptacle without damage to it or provide a removable locking arm system disposed adjacent to the container lid to prevent its opening. The present invention, in comparison, comprises a leverage capability locking means by when a lower pivoting arm with a counterweight rests in a vertical position is matched vertically to a connecting link plate. This dramaticly blocks movement of the second arm that is also connected by the opposite end of the connecting link plate in a horizontally locked orientation, preventing lift, serving as a temporary lock over the closed lid of the receptacle. As the container is tilted forward by a predetermined angle, the weighted first arm moves therefrom the housing structure, exerted by gravity, pushes against the link plate and dislodges the second arm to enable movement from its locked position, clearing the path of travel for the container lid for the waste contents to be removed. Having a properly located stop post on the housing structure to control limited movement for the lock arm and the counterweight arm is essential.

It can be seen that the present invention is an improvement over these prior-art locking devices for wheeled trash containers with hingable lids for attachment assemblies providing a simple, easy to apply without damage, cost efficient, fastenable to said trash containers with hingable lids and the like which meets the criteria desired for such devices.

### BRIEF DISCRIPTION OF THE DRAWINGS

The invention will now be described, by way of example, with reference to the accompanying drawings, in which:

FIG. 1 is a perspective view of an illustrative embodiment of the automatic gravity inforced wheeled trash container hinged lid locking device;

FIG. 2 is a left side view of an illustrative embodiment of the automatic gravity inforced wheeled trash container hinged lid locking device showing the device in a locked position;

FIG. 3 is a right side view of an illustrative embodiment of the automatic gravity inforced wheeled trash container hinged lid locking device in a locked position;

FIG. 4 is a right side view of an illustrative embodiment of the automatic gravity inforced wheeled trash container hinged lid locking device showing the device in an unlocked position;

FIG. 5 is an exploded, front view of an illustrative embodiment of the automatic gravity inforced wheeled trash container hinged lid locking device;

FIG. 6 is a perpective view of an illustrative embodiment of the automatic gravity inforced wheeled trash container hinged lid locking device, showing the residential wheeled trash container equipped with a locking device standing in a closed upright position awaiting pickup by a garbage truck; and

FIG. 7 illusrtates the operation of the device shown in FIG. 1, when the container is emptied shown with respect to a trash container open and an intermediate portion of the container and lid parts removed for convenience of illustration.

### DETAILED DESCIPTION OF THE PREFERRED EMBODIMENT

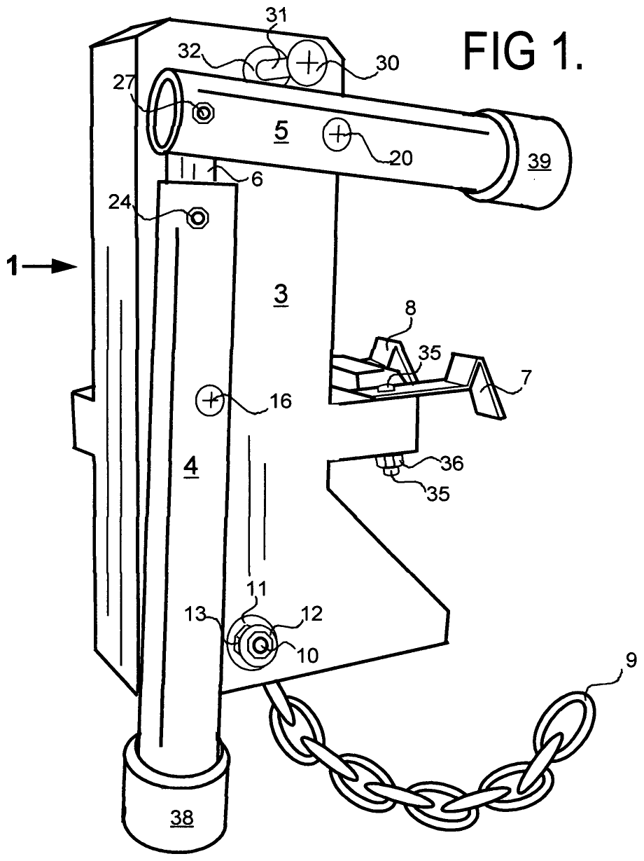

Referring initially to FIGS. 1-7 of the drawings, an illustrative embodiment of the automatic gravity inforced trash container lid locking device 1 shows a housing structure 3 with hooks 7 and 8 and a pair of pivotable affixed arms 4 and 5 connected together by a movable link plate 6 with properly designated stopper posts 10 and 30 and a strap adjustment chain 9. In accordance to the invention 1, an automatically lock and releasable holding arrangement 1, is interposed between lower container body 2 and container hinged lid 41 being held down in a locked position by a horizonal second arm 5 and a cooperative link plate 6 controlled by a vertical first arm 4 with a weighted member 37.

It is to be understood that relative terms used herein are intended to describe relative relationships of components with respect to each other and should not be construed in a limiting sense. Therefore, the components designated by such terms may be oriented in other spatial relationships with respect to each other during use of the automatic gravity inforced trash container lid locking device 1.

The automatic gravity inforced trash container lid locking device 1 shown in FIG. 1 comprises a housing embodiment 3 having two pivoted arms 4 and 5 connected by a link plate 6, two hooks 7 and 8, two stopper posts 10 and 30, a counter weight 37, and an adjustment chain 9 to automatically be attached with said hooks 7 and 8 and lashed to the front handle 43 of a conventional automated trash container 2 supplied by a dumping service to periododically lift and tilt the entire container 2 to a upside down position for dumping waste in the usual manner.

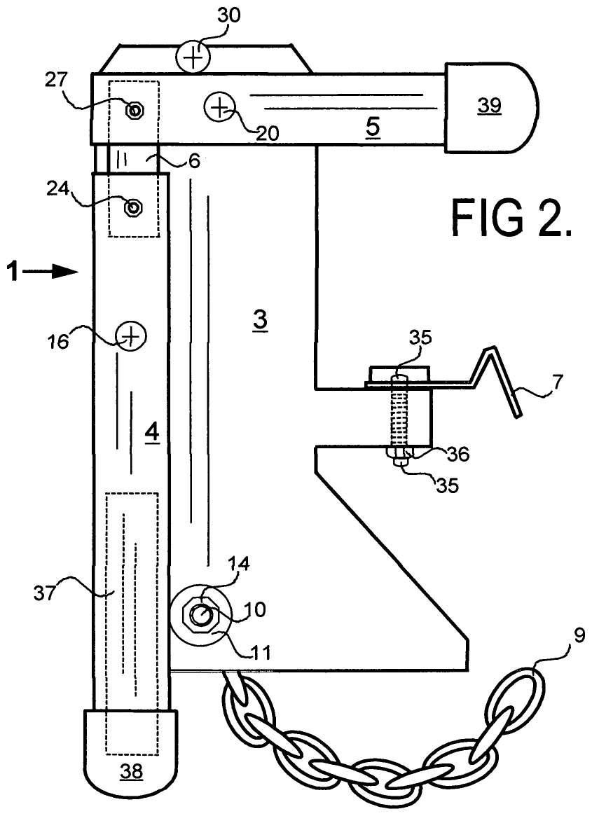

An illustrative embodiment comprises a housing structure 3 shown in FIG. 2 having a properly located stopper post 10 for controllable movement of a first arm 4 to facilitate a secured counterweight 37 on one end, a pivotal location and movable link plate 6 attached to a respective opposite end to a second arm 5 with a pivotal location to further connect the first arm 4 and the second arm 5 to each other. The housing structure 3 further comprises two selective hooks 7 and 8 for the purpose of hanging on the outside edge 42 of an open conventional trash container 2, while the housing structure 3 has an abutment that keeps the device 1 in a somewhat vertical transition to the receptacle 2 and presents a means of fastening a type strap 40 or restraint from the device 1 securely to the trash container 2.

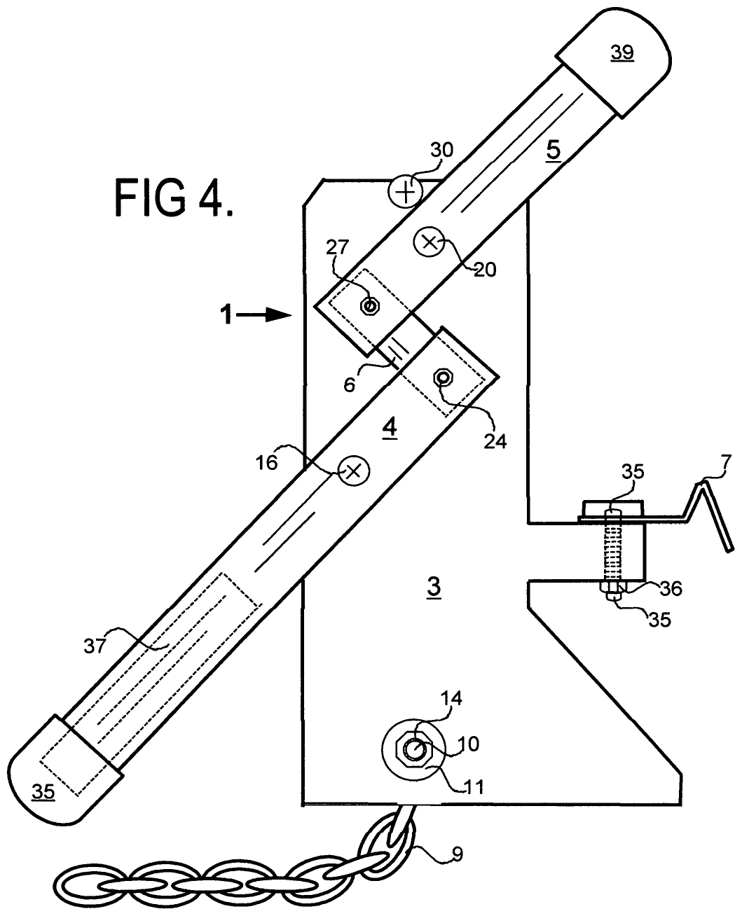

If the vertical lower first arm 4 with the counterweight 37(controlled by a properly placed stopper post 10 for limited movement) and the movable verticle link plate 6 affixed at one end joined at the other end to the upper second arm 5 in a horizonal position (controlled by another properlty placed stopper post 30 for limited movement) and stays perpendicular, the horizonal upper second arm 5, due to its orientation, will remain in a locked position, unable to lift or release said container lid 41 until disengaged as illustrated in FIG.4.

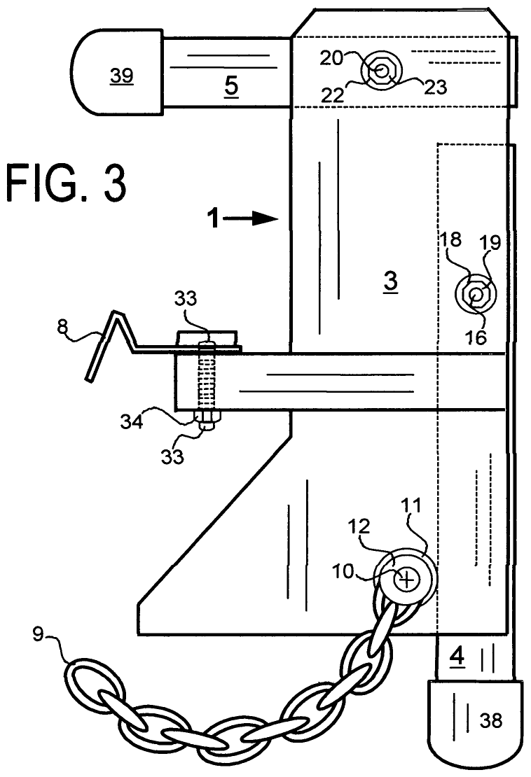

With reference to FIG. 3, the present disclosure may relate to other automatic gravity inforced lid locking devices for wheeled trash containers 2. Such devices may be constructed from a durable material such as heavy duty metal or may be constructed from components that remain simular to conventional polyproplene wheeled trash containers. Regardless to what sufficiently durable materials are used, all may open said containers 2 descrbed without interference during the lock and unlock trasitions to accomplish their goals, though it should be stated, that the present disclosure 1 is not mounted directly to a receptacle 2 using drilled holes, welded or press-fitted for attachment like most and if made from durable PVC material, being lighter in weight, it could serve as an inexpensive alternative for manufacturing. Illustrated are the embodiments of the present disclosure's left side FIG. 3 to comprise the housing structure 3 in its entirety showing the hooks 7 and 8, the adjustment chain 9, both rigid upper and lower pivoting arms 4 and 5 mounted to the right side of the housing structure 3.

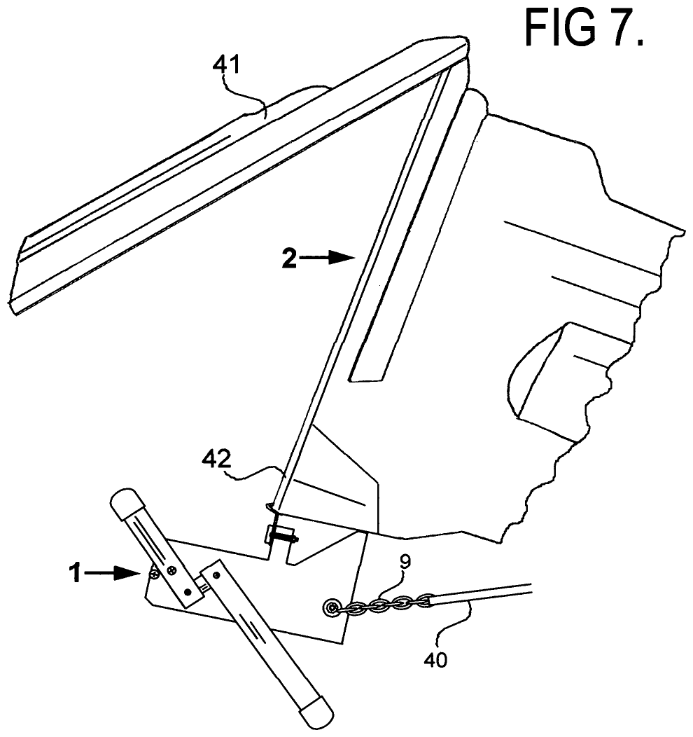

Referring now to FIG. 4, an automatic gravity inforced lid locking device 1 is represented in an unlocked position showing both link plate 6 and connected pivotable arms 4 and 5 mounted on the housing structure 3. The upper horizonal arm 5 and the lower vertical arm 4 with counterweight 37 pivotally moved opposite therefrom the housing structure 3 in a substantially fixed unlocked position by the influence of gravity tilted foward as illustrated in FIG. 7.

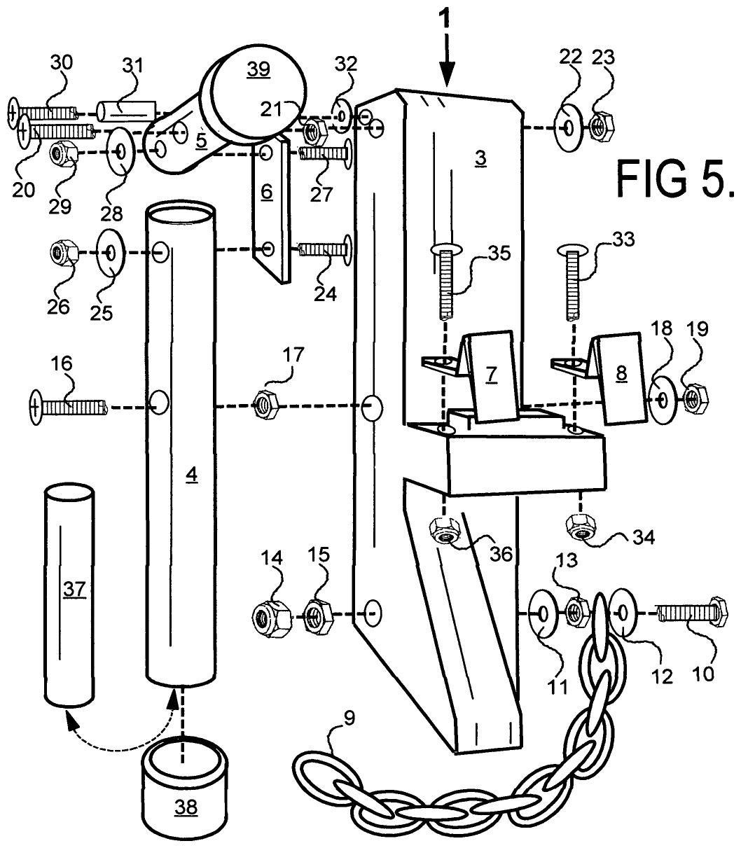

FIG. 5 illustrates an exploded perspective view of the automatic gravity lid locking device 1 as follows: A rigid first pivoting arm 4 is situated in a vertical position affixed to a rigid second pivoting arm 5 situated in a horizontal position by a link plate 6 secured near the end of each said pivoting arm 4 and 5 by means of a bolt 24 and 27, washer 25 and 28 and nylon nut 26 and 29 in such a fashion that both pivoting arms 4 and 5 can rotate freely. The first pivoting arm 4 is fastened to the housing structure 3 by means of a bolt 16, washer 18 and nylon nut 19 wherein a spacer nut 17 is situated between said pivoting arm 4 and the housing structure 3 in order to provide proper spacing for the link plate 6 to move freely. The second pivoting arm 5 is fastened to the housing structure 3 also by means of a bolt 20, washer 22 and nylon nut 23 wherein a spacer nut 21 is situated between said pivoting arm 5 and the housing structure 3 once again to provide proper spacing for the link plate 6 to move freely. A weighted rod 37 is inserted into the bottom of the first pivoting arm 4 and remains in place by means of a cap 38 affixed to the bottom of said pivoting arm 4 and its attachment bolt 16 to the housing structure 3. The second pivoting arm 5 also comprises a cap 39 mainly for aesthetical purposes. The housing structure 3 also comprises two hooks 7 and 8 in the front of the device 1 affixed by a bolt 33 and 35 and nylon nut 34 and 36 for means of hooking onto a trash container's 2 top edge or lip 42. A stopper post bolt 10 comprising a bottom washer 11, a spacer nut 13, an adjustment chain 9 and a top washer 12 is inserted through the left side of the housing structure 3 pertruding out of the right side of the housing structure 3 comprising a spacer nut 15 and a nylon nut 14 now forming the proper length and means of preventing the first pivoting arm 4 from swinging into an incorrect position. For the same purpose, another such means is provided for the second pivoting arm 5 by including a screw 30 with a protective casing 31 followed by a washer 32 and then affixed to the housing structure 3 on the top right side as illustrated.

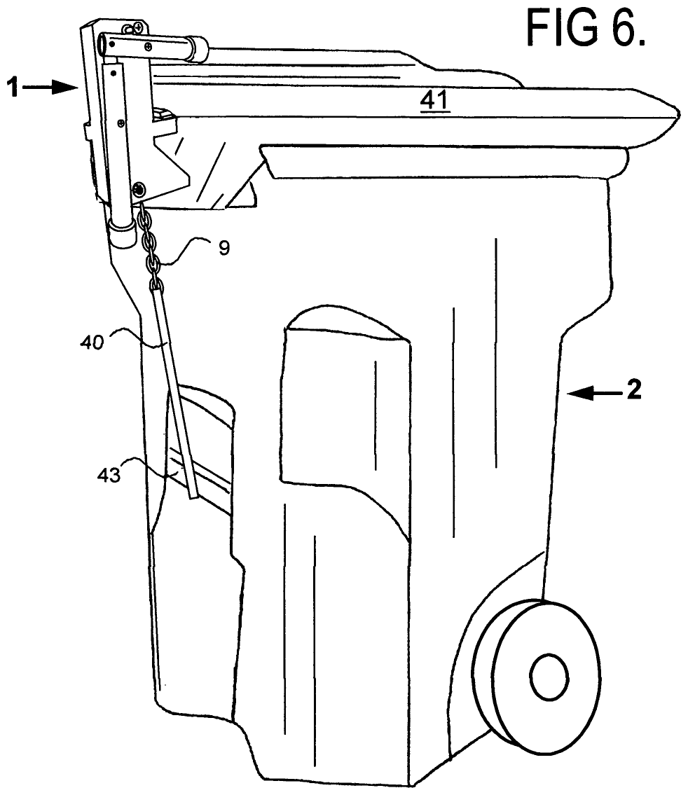

Another embodiment of the invention 1 demostrates preferred intended use wherein it is shown in FIG. 6 to be hooked and strapped to a a conventional, wheeled, residential type trash container 2 used for garbage or recyclable waste constructed of a plastic type material with a shape that is somewhat rectangular on the upper part and is somewhat cylindrical on the lower part having a hinged lid 41 and is generally indicated by reference numeral 2.

In accordance with the invention 1, said horizonal upper arm 5 having the function of holding down the hingable, closed lid 41 of a trash container 2 is shown in a locked position with a lower vertical arm 4 comprising a counterweight 37, so that when said device 1 has been interposed between the outer edge wall 42 of said container 2 by hooks 7 and 8 beneath the closed container lid 41 and the receptacle 2 is in an normal upright position on the ground, it then can be tilted forward by a automated garbage truck for dumping. This causes influencing forces of gravity to move the lower vertical arm 4 outwardly thereof, pushing against the link plate 6 in a cooperative manner, disengaging the upper horizonal arm 5 that then recesses upwardly from its locked position holding down the container lid 41 giving way to clear a path of travel to purge the waste.

As illustrated in FIG. 7 with respect to the trash container 2 being lifted up and tilted forward for dumping, the first arm 4 with the counterweight 37 can pivot outwardly therefrom due to the influence of gravity and push the connecting link plate 6 forward against the second arm 5 forcing it into an unlocked position until it is restricted by a second stopper post 30 so as not to interfere with the hinged lid 41 of the receptacle to achieve clearence for dumping the trash container 2 waste. Thus, when the trash container 2 is emptied and placed back to a substantially upright position and the hinged lid 41 closes, the device 1 returns to a locked position automatically.

Whereas this invention is here illustrated and described with reference to the embodiments thereof presently contemplated as the best mode of carrying out such invention in actual practice, it is to be understood that various changes may be made in adapting the invention to different embodiments without departing from the broader inventive concepts disclosed herein and comprehended by the claims that follow. From the foregoing it will be apparent to those skilled in the art that a variety of changes and modifications can be made in size, shape, type, number and arrangement of parts described without departing from the spirit of this invention and the scope of the attachment claims.

Having thus described my invention and manner in which it may be used, I claim:

1. A method of an automatic gravity inforced lid locking/unlocking device fastenable manually by hook and strap to a plastic dumpable wheeled trash container with hinged lid that traditionally stands upright on the ground, though adapted to be tilted forward into a dumping position by a garbage collecting machine and emptied by an automated service truck; said invention comprises a fastenable housing structure with at least one metal hook that can be placed beneath the hinged lid of said trash container and secured on the front outer edged wall of said container to which at least one length of flexible material is fixed from said described invention that projects outwardly therefrom and secured to a front lower handle of said container, wherein said housing structure comprises an automatic locking and unlocking means, said means comprising a lower first pivoting arm with a counterweight that rests in a vertical position and an upper second pivoting arm with both arms connected mutually by a rigid metal link plate, wherein said upper second pivoting arm in a horizonal position rests directly over said container's closed hinged lid and becomes dramaticly locked, unable to move or lift due to the physical orientation of said metal link plate and said lower first arm with counterweight when they are perpendicular, and can automatically be unlocked when by the use of gravity, said lower first arm with counterweight moves outwardly therefrom said housing structure as said trash container is tilted forward, dislodging said metal link plate and lifting said upper second arm to a vertical position in order to move out of the path of said lid for the dumping process to complete, and then relock said container following dumping, further comprising:
a) two properly located stopper posts on said housing structure to control limited movement for said lower first pivoting arm with counterweight and upper second pivoting arm; and,
b) a chain affixed for means of strap adjustment from said housing structure to a trash container's lower outside handle.

2. An automatic gravity inforced lid locking/unlocking device as in claim 1 wherein said lock mechanism as for example, but certainly not restricted thereto, comprises a hook as in claim 1 thereof on a bracket having an added hook assembly (perhaps with bolt, wingnut and chain) generally connected for the purpose of mounting beneath the exterior front apron wall or molded recess of a conventional wheeled trash container as an attachment means adapted to adjust for tightening. As described above, while said device is hooked as in claim 1 directly below the lid on the upper front edge of said trash container, at least one length of said hook assembly is suspended from said hook bracket on the device to the slotted region of the apron wall or molded recess on said trash container and may substantially be adjusted by a wingnut on a bolt or chain capable of reducing distance between both hooks to sufficiently tighten and provide a secure latching means.

3. An automatic gravity inforced lid locking/unlocking device as in claim 1 wherein said lock mechanism as for example, but certainly not restricted thereto, comprises a fastenable crossbar with affixed end hooks as an attachment means adapted to span the width of the front wall of said conventional wheeled trash container and interiorly receive said hooks on the front corners therein and comprising a centrally located latching member therein to intersect said housing structure having an opening therein disposed to intercept a padlock and hold the device securely while still maintaining a desirable opertion.

4. An automatic gravity inforced lid locking/unlocking device as in claim 1 wherein another lock mechanism as for example, but certainly not restricted thereto, comprises a fastenable wall plate disposed for mounting on said present invention that is first placed up under a petruding lip along the front edge of a certain model trash container design having a bolt disposed through said wall plate, followed thereto by said device with an opening therein and hooked on the front outer edged wall of said receptacle so as both when joined together and secured using a wingnut, provide a locking means to prevent movement.

5. An automatic gravity inforced lid locking/unlocking device as in claim 1 wherein another locking means as for example, but certainly not restricted thereto, comprises a self releasing strap (possibly an elastic strap with hooks at each end) that extends from the front of said device to the rear of said container beneath the back molded expanse at each tappered opposite side of said container.

6. An automatic gravity inforced lid locking/unlocking device as in claim 1 wherein another latching means, as for example, but certainly not restricted thereto, comprises a self releasing strap (possibly an elastic strap with hooks at each end) that may be secured from the somewhat rectangular upper portion of said container on the extended central front edged wall that holds said device in order to wrap said self releasing strap around the lower backside of the somewhat cylindrical lower tapered corners of said container for attachment.

7. An automatic gravity inforced lid locking/unlocking device as in claim 1 wherein another latching means, as for example, but not limited thereto, said adjustment chain on device can extend to a length that reaches said containers lower front outside handle and provide a means of padlocking said device permanently to said trash container to make it tamper proof and prevent theft.

8. An automatic gravity inforced lid locking/unlocking device as in claim 1 wherein another latching means, as for example, but not limited thereto, comprises a plate with a durable post that can be placed under the wide central front edged apron of a particular trash container model so that when said device has been attached to said container they may be secured together with chain and padlock or elastic strapping as a locking means.

9. An automatic gravity inforced lid locking/unlocking device as in claim 1 wherein another latching means, as for example, but not limited thereto, comprises a dirable tee-shaped pipe with an elbow that can be inserted beneath the outside structural lip of a conventional wheeled trash container that may distance said device from said container and be attached by an elastic cord with hooks in the tubular ends.

10. An Automatic gravity inforced lid locking/unlocking device as in claim 1 wherein said latching means, as for example, but not limited thereto, comprises two separete bolts and wingnuts with hooks. One bolt attached to said metal hook or hooks may project horizonally from said device by undeterminable length inserted through the housing structure with a wingnut to allow a user to properly adjust distance from said device to hold on to the front inside edged wall of said trash container while another bolt of undeterminable length may be placed vertically through the housing structure with a hook end that may be mounted below the apron wall on the front side of said trash container to permit a user to essentially tighten a wingnut on said bolt to lift the hook upward into the recesses of the apron cavity to secure the device to the trash container.
